(19) United States
(12) Patent Application Publication
(10) Pub. No.: US 2006/0082886 A1
(43) Pub. Date: Apr. 20, 2006

(54) Transmission type screen and manufacturing method of the same

(75) Inventors: Kenichi Yakushiji, Niigata (JP); Keisuke Adachi, Niigata (JP); Makoto Soyama, Niigata (JP)

Correspondence Address: OSHA LIANG L.L.P., 1221 MCKINNEY STREET, SUITE 2800, HOUSTON, TX, 77010, US

(73) Assignee: Arisawa Mfg. Co., Ltd., Niigata (JP)

(21) Appl. No.: 11/293,549

(22) Filed: Dec. 2, 2005

(30) Foreign Application Priority Data
Dec. 24, 2003 (JP) 2003-428105

(51) Int. Cl. G02B 27/10

(52) U.S. Cl. 359/620

(57) ABSTRACT

There is provided a transmissive type screen having a high contrast and display quality. The transmissive type screen has at least, in order from the side of a light source, a Fresnel lens, a microlens array and a transparent high cross-linking section formed at a focal point of each microlens and has an opaque section around the high cross-linking section centering on an optical axis of each microlens. Here, the opaque section shuts out light by dye molecules dispersed therein.

### CROSS REFERENCE TO RELATED APPLICATION

The present application relates to a Japanese Patent Application No. 2003-428105 Filed on Dec. 24, 2003, the contents of which are incorporated herein by reference.

### BACKGROUND OF THE INVENTION

1. Field of the Invention

The present invention relates to a transmissive type screen and a manufacturing method of the same. More specifically, the invention relates to a transmissive type screen having a fly-eye lens and a manufacturing method of the same.

2. Background Technology

A rear projection display transmits image light outputted from an optical engine through a transmissive type screen to the viewer side. Here, the system is provided with an opaque layer for shutting out or absorbing light on part of the transmissive type screen where the image light does not transmit to increase contrast of the image. As a method for forming such an opaque layer, there has been a method including the steps of laminating a black film through an intermediary of a delamination curable adhesive layer, hardening the adhesive layer at part where image light transmits and removing the black film at the hardened part as disclosed in Japanese Patent Publication Nos. 3243166 and 3309849 for example.

However, the conventional technology described above has had a problem that because hardening of the adhesive layer advances even after the opaque layer is formed, the adhesion of the black film is degraded gradually. Still more, it has had a problem that in removing the unnecessary part of the laminated black film, the black film remains at part where it is not necessary or the black film is peeled off at the part where it is necessary. It has had also a problem the shutout property of the black film might drop as the black film causes delamination.

Accordingly, it is an object of the invention to provide a transmissive type screen that solves the above-mentioned problems. This object may be achieved through the combination of features described in independent claims of the invention. Dependent claims thereof specify preferable embodiments of the invention.

### SUMMARY OF THE INVENTION

According to a first aspect of the invention, a transmissive type screen has at least, in order from the side of a light source, a Fresnel lens, a microlens array and a transparent high cross-linking section formed at a focal point of each microlens, and has further an opaque section around the high cross-linking section centering on an optical axis of each microlens and the opaque section shuts out light by dye molecules dispersed therein.

Here, the interval of molecules in the opaque section is desirable to be larger than the molecular interval of the high cross-linking section.

Still more, the high cross-linking section is desirable to be formed of light curable resin whose cross-linking advances by light energy and to be cross-linked to have molecular interval finer than molecular size of the dye.

The high cross-linking section and the opaque section are desirable to be formed as portions of the light curable resin provided on the opposite side from the light source of the microlens array and the high cross-linking section is desirable to be formed so as to penetrate through the light curable resin in the direction of the optical axis.

The surface of the light curable resin farther from the light source is desirable to be positioned on the outside of the focal point of the microlens array.

The opaque section is desirable to be composed of polymers including aromatic rings.

The opaque section is desirable to have a cross section in the direction vertical to the optical axis, which is smaller on the side closer to the light source.

The opaque section is desirable to be formed by dispersing dye molecules in part of a transparent resin layer provided on the opposite side from the light source of the microlens array and the opaque section is desirable to penetrate through the transparent resin layer in the direction of the optical axis.

According to a second aspect of the invention, a manufacturing method of a transmissive type screen having at least, in order from the side of a light source, a Fresnel lens and a microlens array, includes steps of forming a transparent light curable resin layer whose molecular interval is larger than the size of dye molecules to the vicinity of a focal point of the microlens array on the opposite side from the light source, cross-linking the light curable resin layer in the vicinity of the focal point by irradiating light almost parallel with the optical axis of the microlens array from the light source side and forming an opaque section for shutting out light by the dye molecules dispersed in non-cross-linking area of the resin layer by contacting fluid medium containing the dye molecules with the light curable resin layer.

The light curable resin layer is desirable to be formed to the outside of the focal point of the microlens array.

The transmissive type screen manufacturing method is desirable to include also a step of dispersing the dye molecules in fluid medium whose affinity with the dye molecule is lower than the light curable resin layer as a step of preparing the fluid medium containing the dye molecules.

The dye molecules are desirable to be dispersed within fluid medium mainly composed of water as the step of preparing the fluid medium containing the dye molecules.

It is also desirable to provide a transparent diffuser between the light source and the microlens array, to input almost parallel light to the diffuser and to input the outgoing light outputted from the diffuser to the microlens array in the step of cross-linking the resin in the vicinity of the focal point.

According to a third aspect of the invention, a manufacturing method of a transmissive type screen having at least, in order from the light source side, a Fresnel lens and a microlens array, includes steps of forming a transparent dyeable resin layer whose molecular interval is larger than the size of dye molecules to the vicinity of a focal point of the microlens array on the microlens array on the opposite side from the light source of the dyeable resin layer, forming a transparent light curable resin layer on the dyeable resin layer on the opposite side from the light source, cross-linking the light curable resin layer in the vicinity of the focal point by irradiating light almost parallel with the optical axis of the microlens array from the light source side and forming an opaque section for shutting out light by the dye molecules dispersed in non-cross-linking area of the resin layer by contacting fluid medium containing the dye molecules with the light curable resin layer.

It is noted that the summary of the invention described above does not necessarily describe all the necessary features of the invention. The invention may also be a sub-combination of the features described above.

### BRIEF DESCRIPTION OF THE DRAWINGS

FIG. 1A is a drawing showing a configuration of a rear projection display.

FIG. 1B shows an exemplary visual angle-luminance distribution characteristic when an incident angle of image light incident on a transmissive type screen is not corrected.

FIG. 1C shows an exemplary visual angle-luminance distribution characteristic when an incident angle of image light incident on the transmissive type screen is not corrected.

FIG. 1D shows an exemplary visual angle-luminance distribution characteristic when an incident angle of image light incident on the transmissive type screen is not corrected.

FIG. 2 shows one exemplary desirable visual angle-luminance distribution characteristic of outgoing light.

FIG. 3 is a drawing showing a configuration of a transmissive type screen having the characteristic shown in FIG. 2.

FIG. 4A is a chart showing an exemplary visual angle-luminance distribution characteristic corresponding to a use of the transmissive type screen.

FIG. 4B is a chart showing an exemplary visual angle-luminance distribution characteristic corresponding to another use of the transmissive type screen.

FIG. 5 is a chart showing routes of the image light transmitting through the transmissive type screen,

FIG. 6A is a drawing showing a manufacturing step of a microlens unit.

FIG. 6B is a drawing showing the manufacturing step of the microlens unit.

FIG. 6C is a drawing showing the manufacturing step of the microlens unit.

FIG. 6D is a drawing showing the manufacturing step of the microlens unit.

FIG. 6E is a drawing showing the manufacturing step of the microlens unit.

FIG. 6F is a drawing showing the manufacturing step of the microlens unit.

FIG. 7A is a drawing showing a vertical section profile of a lens unit cell.

FIG. 7B is a drawing showing the vertical section profile of the lens unit cell.

FIG. 7C is a drawing showing the vertical section profile of the lens unit cell.

FIG. 7D is a drawing showing the vertical section profile of the lens unit cell.

FIG. 8 shows an embodiment in which a lens-side masking layer is used to prevent a microlens array from being dyed.

FIG. 9 shows a detail when ultraviolet light is irradiated in the step shown in FIG. 6C or 7B.

FIG. 10 is a drawing showing one exemplary detailed profile around a high cross-linking section.

### DETAILED DESCRIPTION OF THE INVENTION

The invention will now be described based on preferred embodiments while showing operations of the invention based on the drawings, which do not intend to limit the scope of the invention, but exemplify the invention. All of the features and the combinations thereof described in the embodiments are not necessarily essential to the invention.

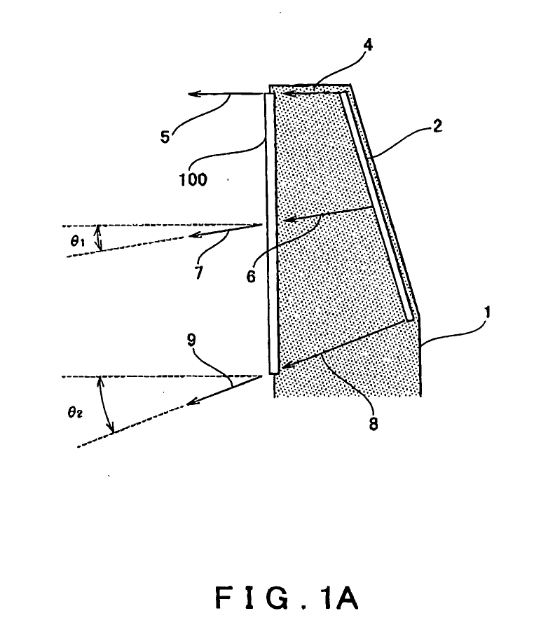

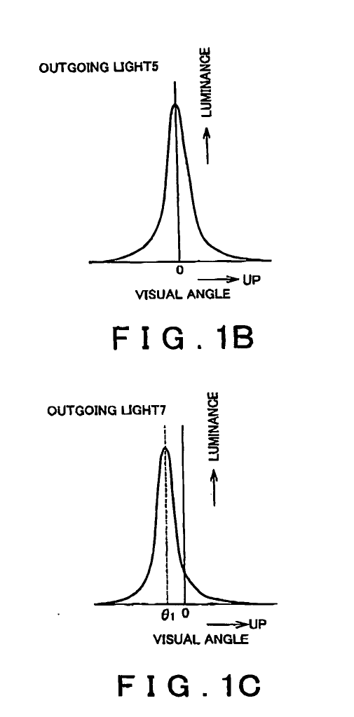

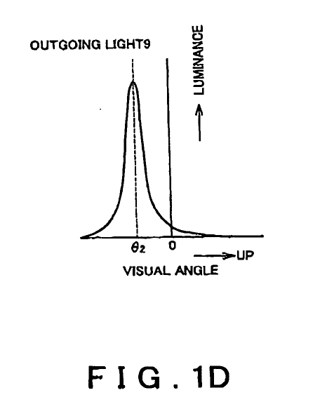

FIG. 1A shows a configuration of a rear projection display 1. The rear projection display 1 has an optical engine 2 for outputting image light, an optical system not shown for projecting the outputted image light and a transmissive type screen 100 for transmitting the image light projected by the optical system to the viewer side. The transmissive type screen 100 gives a predetermined visual angle-luminance distribution characteristic to the outgoing light to the viewer side by diffusing incident lights 4, 6 and 8, respectively. Because incident angles of the incident lights 4, 6 and 8 incident on the transmissive type screen 100 are different from each other at this time, the direction where intensity of the outgoing light is maximized will differ per each outgoing light if they are diffused as they are.

FIGS. 1B, 1C and 1D show exemplary visual angle-luminance distribution characteristics when the transmissive type screen 100 does not correct the angle of the incident lights 4, 6 and 8. Here, the visual angle is an angle made between a line vertical to the screen surface and a line of sight of a viewer, When the incident light 4 incident vertically on the transmissive type screen 100 becomes outgoing light 5 having a maximum luminance in a visual angle of 0 as shown in FIG. 1B as a result of that it is diffused within a certain range. The incident light 6 incident on the transmissive type screen 100 with an incident angle of θ₁ becomes outgoing light 7 having a maximum luminance in a visual angle of θ₁ as shown in FIG. 1C as a result of that it is diffused within a certain range. In the same manner, the incident light 8 incident on the transmissive type screen 100 with an incident angle of θ₂ becomes outgoing light 9 having a maximum luminance in a visual angle of θ₂ as shown in FIG. 1D. If the visual angle having the maximum luminance is different depending on the position on the screen as described above, the luminance of the image light seen from the viewer is not homogeneous in the whole screen and hence it is not preferable. Accordingly, it is necessary to equalize the visual angle-luminance distribution characteristics in the whole screen in order to obtain favorable display quality. specifically, it is desirable to design so that the luminance of the outgoing light in front of the transmissive type screen 100, i.e., at the visual angle of 0°, is maximized.

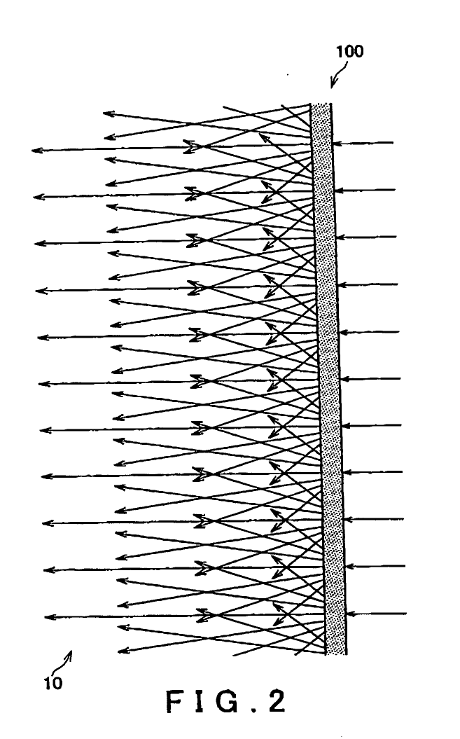

FIG. 2 shows an exemplary desirable visual angle-luminance distribution characteristic of outgoing light 10. Here, the length of each arrow indicates the strength of a ray in that direction. The transmissive type screen 100 may have the good display quality by thus equalizing the visual angle-luminance distribution characteristics in the whole screen.

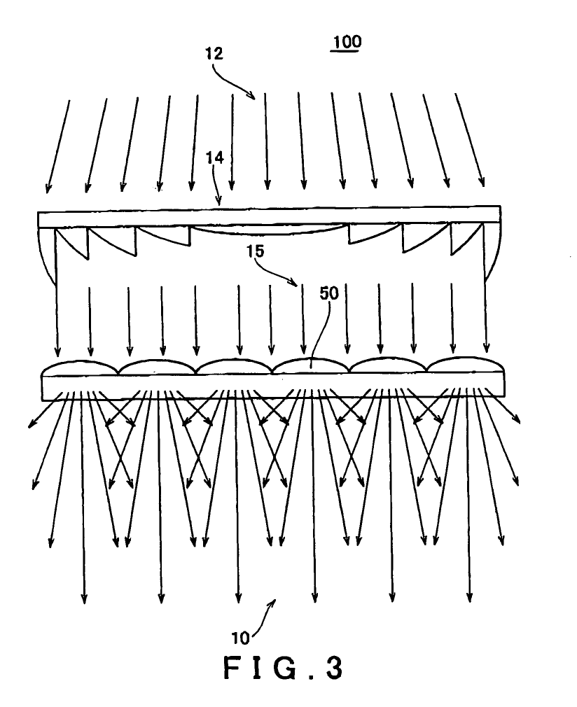

FIG. 3 shows a configuration of the transmissive type screen 100 having the characteristic shown in FIG. 2. The transmissive type screen 100 has, in order closer to the optical engine, a Fresnel lens 14 and a microlens unit 50. The Fresnel lens 14 collimates the whole image light 12. The microlens unit 50 diffuses almost parallel right 15 collimated by the Fresnel lens 14 with a predetermined angle and outputs the outgoing light 10 to the viewer. The outgoing light 10 has a homogeneous visual angle-luminance distribution characteristic across the whole transmissive type screen 100. Empirically, even if the relative position of the image light and a lenslet (single microlens composing the microlens array) deviates, it will hardly lead to a deterioration of resolution by setting a pitch of the lenslets to be less than ⅕ of a pitch of the image light projected from the optical engine.

The visual angle-luminance distribution characteristic of the outgoing light 10 is determined depending on the shape of each lens unit cell of the microlens unit 50. The visual angle-luminance distribution characteristic required for the transmissive type screen is different depending on uses of the display.

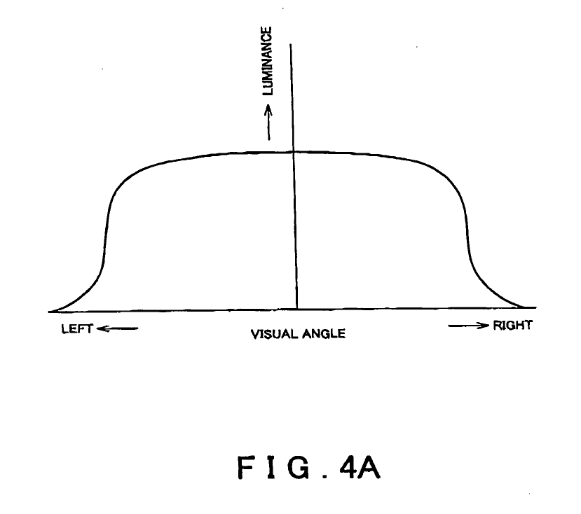

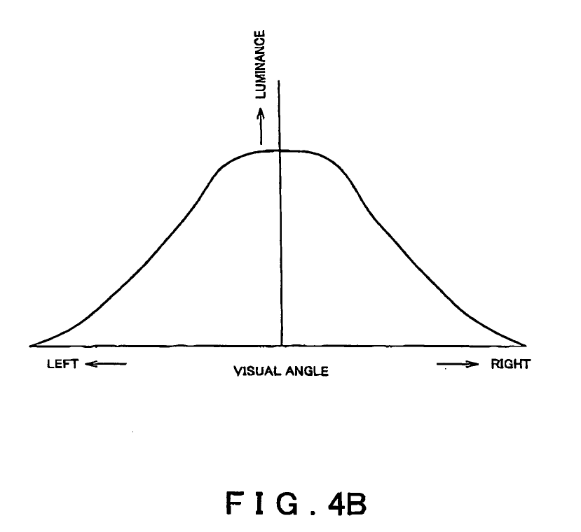

FIGS. 4A and 4B show examples of the visual angle-luminance distribution characteristics corresponding to the uses of the transmissive type screen. FIG. 4A shows the visual angle-luminance distribution characteristic of the transmissive type screen suited for displaying data such as a computer monitor. In the case of the use for displaying data, characteristics having a homogeneous luminance across the whole screen is required for all the viewers within a range of an effective angle of view field. To that end, the shape of each lenslet is designed so that the intensity of each outgoing light 10 is equalized in the whole output angle direction within the range of effective angle of view field.

FIG. 4B shows the visual angle-luminance distribution characteristic of the transmissive type screen suited for the use viewed by a large number of viewers at the same time such as a television set. In this case, the diffusing characteristic is determined based on a design concept that it is preferable to gradually change the display quality corresponding to the position of the viewers within the range of effective angle of view field. Normally, the shape of each lenslet is designed so that the luminance is maximized when seen from the right front, i.e. , from the visual angle of 0°, and so that the luminance drops gradually as the visual angle increases. Most of the present projection displays are designed so as to have such characteristics.

It is noted that although a cylindrical lens array having a converging action only in single axial direction is generally used as the microlens array, a fly-eye lens having the converging action in the direction of two axes or more may be used instead of the cylindrical lens. Still more, a ball lens array in which small globular lenses are arrayed may be used. The desirable visual angle-luminance distribution characteristics may be realized in the direction of two axes or more by using the fly-eye lens and ball lens arrays.

By the way, in order to increase a contrast which is an important display characteristic of the rear projection display 1, the luminance in non-lighting must be lowered while maintaining the maximum luminance in lighting. To that end, it is effective to provide an opaque layer on part of the screen where the image light does not pass and to maximize a ratio of the area of the opaque layer within a range not hampering the passage of the image light.

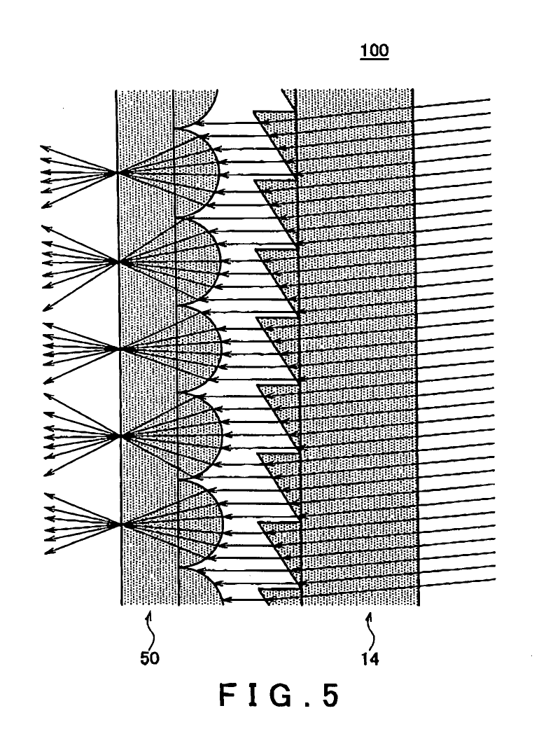

FIG. 5 shows routes of the image light transmitting through the transmissive type screen 100. The image light outputted from the optical engine 2 enters the transmissive type screen 100 via the predetermined optical system. The rays incident on the transmissive type screen 100 transmit through the Fresnel lens 14 at first. The Fresnel lens 14 arranges, i.e., collimates, the incident light as rays almost vertical to the transmissive type screen 100 and almost parallel to each other.

The image light collimated by the Fresnel lens 14 enters the microlens unit 50 next. Each lenslet of the microlens unit 50 converges the incident light to its focal point corresponding to the characteristics of the lens. That is, the incident light incident on the transmissive type screen 100 passes through only the focal point of each lenslet to be transmitted to the viewer side. A shape formed by the focal point of each lenslet is a linear array arrayed at equal intervals corresponding to the lens pitch in case of the cylindrical lens array and an array of points arrayed at equal intervals corresponding to the lens pitch in case of the fly-eye lens. Actually, although the focal point has a certain degree of extent depending on precision in manufacturing the lens, the converging characteristics of the lenslet, aberration and others, a ratio of the area on the focal plane occupied by the focal point is very low. Accordingly, the transmissive type screen 100 may have a high contrast by covering the part of the screen other than the focal points by an opaque layer such as a black material. It then allows the ratio of the area of the opaque layer to be maximized without lowering the luminance of the image light.

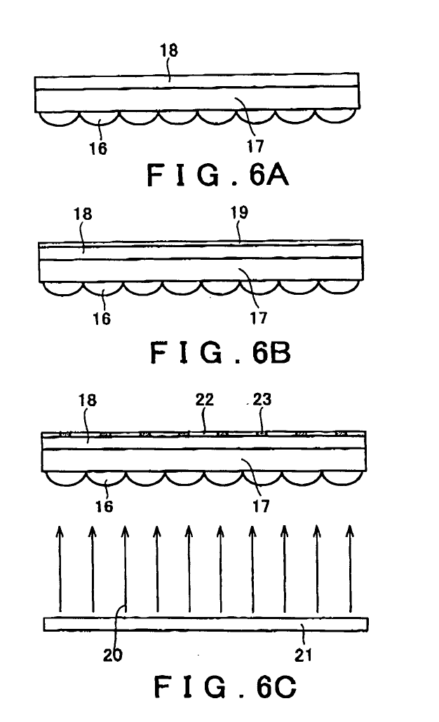

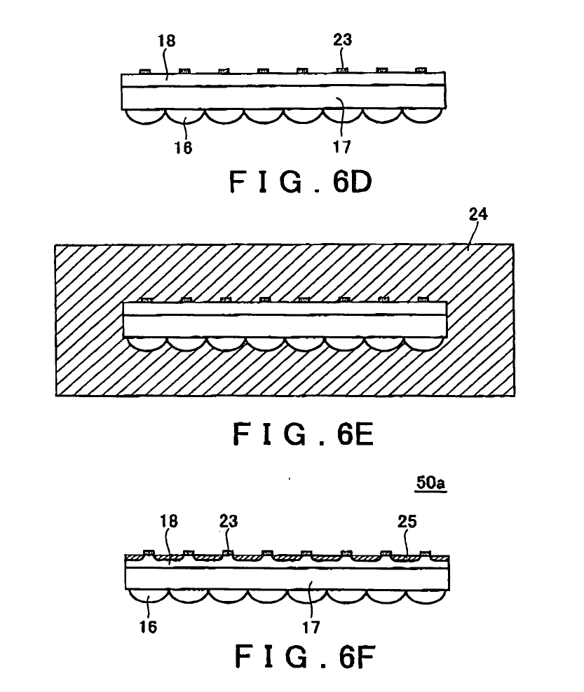

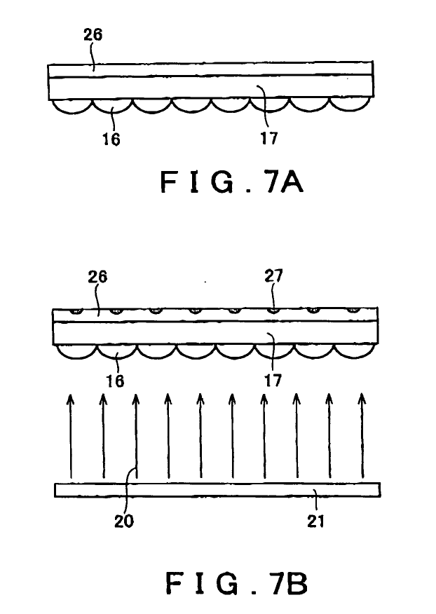

FIGS. 6A through 6F show manufacturing steps of a microlens unit 50a of the present embodiment. Among those steps, a configuration of the microlens unit 50a obtained in the end will be explained by using FIG. 6F at first.

The microlens unit 50a has a microlens array 16 and a transparent high cross-linking section 23 formed at the focal point of each microlens as well as an opaque section 25 formed around the high cross-linking section 23 centering on an optical axis of each microlens. The microlens array 16 is formed on a lens substrate 17 and a transparent dyeing layer 18 is formed on the opposite side of the lens substrate 17. The high cross-linking section 23 is formed directly on the dyeing layer 18 at the part of the focal point of each lenslet. Exemplary dimension of each part may be cited as follows: the pitch of the lenslets is 100 m, a diameter of the high cross-linking section 23 in the direction vertical to the optical axis of the lenslet is 20 μm, a thickness of the microlens array 16 is 100 m and a thickness of the dyeing layer 18 is around 2 μm.

The opaque section 25 is formed by dispersing dye molecules to exposed portions of the dyeing layer 18. The opaque section 25 shuts out light by the dye molecules dispersed therein. Because the opaque section 25 is formed by dispersing the dye molecules therein, its fixing strength to the microlens unit 50 will not change by elapse of time. Still more, the light blocking effect of the opaque section 25 will not drop locally due to the delamination which would occur in case of selectively peeling the black film.

The manufacturing process of such microlens unit 50a will be explained below. The microlens array 16 and the lens substrate 17 are formed through the following steps at first. The microlens array 16 is formed by molding transparent resin by a mold. The mold for the microlens array 16 is prepared by transferring a shape of a master by means of electro forming or the like. The master may be prepared by gray scale photolithography and laser abrasion for example. It maybe used as a sheet-to sheet system or as a roller-to-roll system. The microlens array 16 and the lens substrate 17 may be formed in a body by sandwiching the resin material between the mold fabricated as described above and the lens substrate 17 made from a plastic film and by applying pressure. At this time, the thickness of the lens substrate 17 is selected so that the opposite side of the lens substrate 17 from the microlens array 16 reaches to the vicinity of the focal plane of the microlens array 16.

The resin material used for molding the microlens array 16 may be any resin such as thermoplastic resin and thermosetting resin as long as it is a material transparent to visual light. General-purpose plastic film may be used as the plastic film used for the substrate. The plastic film may be selected from polyethylene terephthalate, polycarbonate, acrylic resin and the like.

Next, in a step shown in FIG. 6, the dyeing layer 18 whose molecular interval is larger than the dye molecule is formed to the area very close to the focal point of the microlens array 16 on the opposite side from the light source of the microlens array 16. The dyeing layer 18 is one example of the inventive dyeable resin layer. The dyeing layer 18 is formed by laminating a transparent dyeable coating film on a flat plane of the lens substrate 17 on which the microlens array 16 is formed on the other face thereof. For the dyeing layer 18, it is preferable to use a material whose cross-linking density is low enough to permit the dye molecules to infiltrate into molecular chains relatively easily and whose affinity with the dye is relative high

The good affinity of the dyeing layer 18 with the dye means that wettability of a polymer material forming the dyeing layer 18 with the dye is good. Here, because dye has aromatic ring in general, the dyeing layer 18 is specifically preferable to be polymer containing the aromatic ring. That is, the dyeing layer 18 may be formed of polymer and/or copolymer of polymeric monomer having a benzene ring or a naphthalene ring for example. As the polymer material described above, while bisphenol A type polycarbonate, polyethylene terephthalate and the like may be cited as general-purpose polymer, it may be also diallyl phthalate/benzene methacrylate copolymer, bisphenol type epoxy/dicaboxylic acid copolymer, polybenezyl methacrylate, phenolic resin or epoxy resin.

Still more, because the cross-linking density of the dyeing layer 18 is low enough to permit the dye molecules to infiltrate into the molecular chains relatively easily, the dye infiltrates easily into the molecular chains and can reach easily to the depth in the latter steps. When the cross-linking density is so high that the interval of the molecular chains is smaller than the dye molecule, the dyeing layer 18 has no dyeability. When the cross-linking density is too low, on the contrary, the dyeing layer 18 lacks formal stability. Still more, when the dyeing layer 18 is formed of non-cross-linking polymer, it is desirable to have molecular distance larger than the dye molecule and to be amorphous. Thereby, the infiltration of the dye will not be hampered by crystal.

The dyeing layer 18 is formed as follows for example. A small amount of azobisisobutyronitrile is added to a polymeric monomer system in which diallyl isophthalate and benzene methacrylate are mixed and is pre-polymerized while agitating within the group diluted twice with methylisobutyl ketone to increase its viscosity to an adequate level. A small amount of silicone series or fluorochemical surfactant is then added to it as a leveling agent. It is then applied to the plane of the lens substrate 17 on the opposite side from the microlens array 16 by means of spin coating, bar coating or the like and is heated again to complete the polymerization.

It is noted that the thickness of the dyeing layer 18 is determined by its light blocking effect when the dye molecules infiltrate, are diffused and are held inside. That is, although a relatively thin film will do when the density of dye within the dyeing layer 18 may be high, the thickness is increased when the density of dye cannot be high to assure the light blocking effect.

Next, in a step shown in FIG. 6B, a transparent pre-masking layer 19 is laminated on the dyeing layer 18 on the opposite side from the light source. The pre-masking layer 19 is one example of the light curable resin layer in this invention and its cross-linking density increases by light cross-linking reaction. As a material of this sort, there is a photocrosslinking composition containing multifunctional acrylic monomer for example. The dyeing layer 18 and the pre-masking layer 19 are both formed by applying the light curable resin dissolved by solvent to a mold releasing film, by drying the resin into a film and by pressure bonding the film. It assures high adhesion of the resin to the lens substrate 17 or to the dyeing layer 18. Or, the resin may be formed by drying after its application.

The pre-masking layer 19 is formed specifically as follows. An equivalent weight mixture of methyl methacrylate and allyl methacrylate is mixed with an equivalent weight of methyl ethyl ketone and a few amount of benzoyl peroxide is added to the product to pre-polymerize while heating. Then, propylene glycol diacrylate of an amount almost half of that of the monomer group added at the beginning of is added to the reaction product whose viscosity has been increased as a result. Then again, a few amount of benzoil peroxide, benzohenone as sensitizer and a few amount of silicone series surfactant as leveling agent are added to the product, which is then, applied on the dyeing layer 18. After that, the applied layer is dried to evaporate methyl etyl ketone and to form the pre-masking layer 19.

Next, in a step shown in FIG. 6C, the high cross-linking section 23 is formed at each focal point of the microlens array 16. More specifically, ultraviolet light 20 almost parallel to the optical axis of the microlens array 16 is irradiated from an ultraviolet lamp 21 so as to cross-link the pre-masking layer 19 in the vicinity of the focal point of the microlens array 16. The ultraviolet ramp 21 has a high-pressure mercury lamp for example as a light source. The ultraviolet light 20 is collimated so that an incident angle of the ultraviolet light 20 incident on the microlens array 16 becomes almost vertical to the principal plane, i.e., to the plane on which the microlens array 16 is formed. The intensity and irradiating time of the ultraviolet light 20 are determined corresponding to the reactivity of the photocrosslinking component used for the pre-masking layer 19.

The pre-masking layer 19 is added with cross-linking agent, atomic group, catalyst and the like in advance. Then, light energy density increases around the focal point of each lens due to the light condensing effect of the microlens array 16. The cross-linking reaction advances at part where the light energy density exceeds a threshold value of the cross-linking reaction. When the cross-linking reaction advances and the density of molecular chains increases to the level that permits no dye molecule to infiltrate, part of the pre-masking layer 19 transforms into non-dyeable high cross-linking section 23. As the cross-linking advances, the high cross-linking section 23 increases its adhesion strength to the dyeing layer 18 and hardness.

In this step, the ultraviolet light passes through a very narrow range on the plane of focal point by the light converging effect of each lenslet, Accordingly, the high cross-linking section 23 may be formed by cross-linking the pre-masking layer 19 only in the vicinity of the focal point by adequately selecting the intensity and irradiating time of the ultraviolet light. The high cross-linking section 23 functions as a masking layer to dye in the later step.

Next, in a step shown in FIG. 6D, a low cross-linking section 22 which is a part of the pre-masking layer 19 remained without being cross-linked in the step in FIG. 6C is removed. It will lead to a favorable result when temperature in the succeeding steps is relatively high as compared to a case of not removing the low cross-linking section 22. Still more, removing the low cross-linking section 22 allows the dye to be dispersed to desirable parts in a short time and the opaque section 25 to be formed efficiently. However, if the low cross-linking section 22 has a high affinity with the dye and has a large molecular interval of the level that permits the dye molecules to infiltrate easily, the low cross-linking section 22 needs not be always removed. It is because such low cross-linking section 22 will not hamper a dyeing process of the opaque section 25 in the later step.

In a step shown in FIG. 6E, fluid medium 24 containing the dye molecules is caused to contact with the dyeing layer 18 to diffuse the dye molecules within the dyeing layer 18. Thereby, the opaque section 25 for shutting out light by the dye molecules is formed as shown in FIG. 6F. At this time, the high cross-linking section 23 functions as a masking layer to the dye and prevents the dye from infiltrating into the dyeing layer 18 near the focal point of the microlens array 16.

The dye used here is preferable to be black and one in which subtractive color mixture of three primary colors of cyan, yellow and magenta are mixed with an adequate ratio is used in general. There is also a method of mixing a fourth color. The mixing ratio of these dyes is determined corresponding to the targeted hue in forming the opaque section 25 by dyeing the dyeing layer 18 and to the affinity of materials of the fluid medium 24 and the dyeing layer 18.

Generally, dye is composed of low molecular weight molecules containing n electron series and has a high affinity with aromatic organic solvents. Accordingly, it may be dissolved easily in the aromatic organic solvent. However, when the affinity of the member to be dyed with the dye is lower than that with the aromatic organic solvent, the dye molecule hardly moves to the member to be dyed and hence it is not preferable. Accordingly, a substance whose affinity with the dye molecule is lower than that with the dyeing layer 18 is selected as the dye carrier.

As the dye carrier described above, water or water-soluble paste, i.e., hydrophilic polymer such as polysaccharide, is appropriate. A substance that indirectly increases the affinity between the dye molecules and the dye carrier is added to such dye carrier. It mediates the dissolution or the molecular dispersion and retention of the dye molecules. Such additive is called as dispersant and has functions of increasing solubility and dispersibility of the dye molecules like surfactant and pH adjuster. The process for dyeing the dyeing layer 18 by using the fluid medium 24 in which the dye is dispersed is selected corresponding to the fluid characteristics of the fluid medium 24.

For example, a process of using water as the fluid medium is called as bath dyeing in general. The member to be dyed is soaked into the dyeing bath in which the dye is dispersed in water together with dyeing auxiliaries. Meanwhile, a process of using paste as the fluid medium 24 is called as textile printing in general and normally, color paste in which the disperse dye is dispersed in the water-soluble paste is applied to the surface of the dyeing layer 18. Thereby, the dye moves from the color paste to the dyeing layer 18, thus forming the opaque section 25. When the paste is used as the fluid medium 24, it is possible to contact the color paste only with the face of the dyeing layer 18 to be dyed because viscosity of the color paste is high. Accordingly, there is no possibility of dyeing the microlens array 16.

In either cases of the bath dyeing and textile printing, the speed of diffusing the dye molecules into the member to be dyed increases as they are heated after contacting the dye carrier to the member to be dyed. Then, this state is held for a predetermined period of time. After passing the required time, the member is taken out of the dyeing bath, for the bath dyeing, to clean. The microlens unit 50a shown in FIG. 6F is thus manufactured through the steps described above.

Next, another structure of the microlens unit 50 and an exemplary manufacturing method thereof will be explained as another embodiment. According to this embodiment, the dyeing layer 18 and the pre-masking layer 19 which are laminated separately in the embodiment described above will be made on the same layer. It is noted that only parts different from those of the foregoing embodiment will be explained in the present embodiment. The other manufacturing steps are the same with those of the embodiment described above, so that their explanations will be omitted here. Still more, the same components will be denoted by the same reference numerals and their explanations will be omitted here.

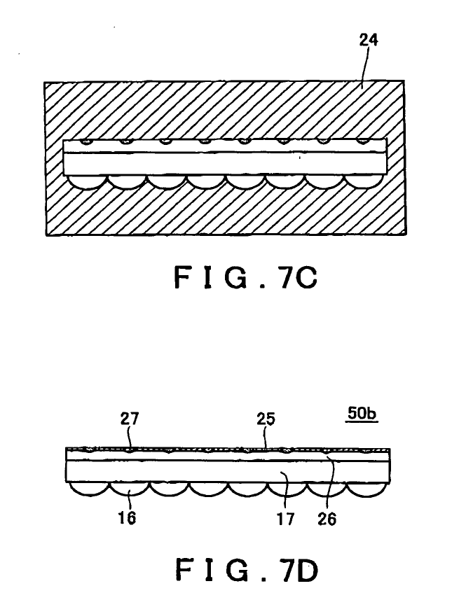

FIGS. 7A through 7D drawings each showing a vertical section profile of a lens unit cell. In a step shown in FIG. 7A, a transparent cross-linking dyeing layer 26 whose molecular interval is larger than the dye molecule is formed on the lens substrate 17 around to the focal point of the microlens array 16 on the opposite side from the light source. The cross-linking dyeing layer 26 is formed to the outside of the focal point of the microlens array 16. The cross-linking dyeing layer 26 is one example of the inventive transparent resin layer.

As a material composing the cross-linking dyeing layer 26, a complex of a polymer material having an affinity with the dye and a light cross-linking material may be used. Such complex may be, for example, a mixture of copolymer of benzyl methacrylate and glycydil methacrylate and pentaerythritol tetraglycidyl ether, a mixture of copolymer of benzyl methacrylate and allyl methacrylate and trimethylol propanetriacrylate and the like. The former one is capable of causing the cross-linking reaction only in a region where a quantity of light more than a threshold value is absorbed through photo-cationic catalyst and the latter one through photo-radical catalyst.

Next, in a step shown in FIG. 7B, the ultraviolet light 20 almost parallel to the optical axis of the microlens array 16 is irradiated from the ultraviolet lamp 21 to advance the cross-linking reaction in the cross-linking dyeing layer 26 around the focal point of the microlens array 16. When the cross-linking reaction advances and the density of molecular chains increases to the level which does not permit dye molecules to infiltrate, a part of the cross-linking dyeing layer 26 transforms into a non-dyeable high cross-linking section 27.

When the cross-linking dyeing layer 26 is relatively thick and the area where the cross-linking reaction advances is limited only to the surface layer of the cross-linking dyeing layer 26, a high cross-linking section 27 is formed only on the surface layer part of the cross-linking dyeing layer 26 as shown in FIG. 7B. The high cross-linking section 27 functions as a masking to the dye in the later dyeing step.

Next, in step shown in FIG. 7C, the fluid medium 24 containing the dye molecules is contacted with the cross-linking dyeing layer 26 so that the dye molecules diffuse to the area of the cross-linking dyeing layer 26 which has not transformed into the high cross-linking section 27 in the step in FIG. 7B. Thus, the opaque section 25 for shutting out light by the dye molecules is formed. The microlens unit 50b shown in FIG. 7D may be manufactured through the steps described above.

A supporting plate having higher rigidity is pasted to the completed microlens unit 50a or 50b on the opposite side from the microlens array 16, i.e., on the side of the high cross-linking section 23 or 27 to assure required rigidity. A scattering member may be added to the supporting plate so as to be able to widen the diffusing angle of the outgoing light.

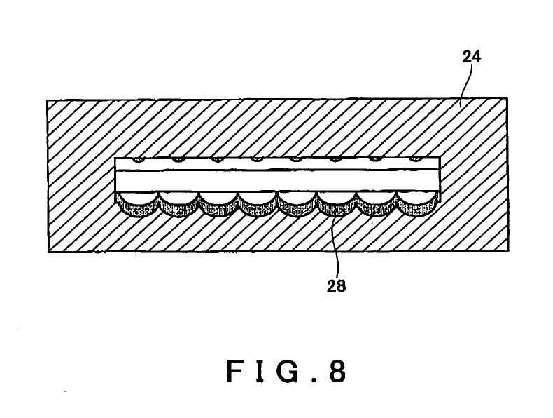

FIG. 8 shows an embodiment for preventing the microlens array 16 from being dyed by providing a lens-side masking layer 28 in the step in FIG. 6E or FIG. 7C. It is effective to provide the lens-side masking layer 28 on the microlens array 16 in order to prevent the microlens array 16 from being dyed in forming the opaque section 25 in those steps. The lens-side masking layer 28 is desirable to be formed of transparent resin into which no dye molecule infiltrates.

The lens-side masking layer28 is effective in particular in the bath dyeing in which the whole member to be dyed is soaked into the fluid medium 24. The lens-side masking layer 28 is removed after the opaque section 25 is formed. However, when it is difficult to remove the lens-side masking layer 28, it is preferable to form the lens-side masking layer 28 into a shape that does not require the lens-side masking layer 28 to be removed, i.e., into a shape that will give no adverse effect to the optical characteristics of the microlens unit 50.

For example, the lens-side masking layer 28 is formed into a shape that will cause no optical distortion by its curvature. Although the lens-side masking layer 28 maybe easily formed through high density cross-linking reaction of polymer materials, it is very difficult to release it from the microlens array 16 in this case. Accordingly, the lens-side masking layer 28 is formed into the shape that will cause no optical distortion.

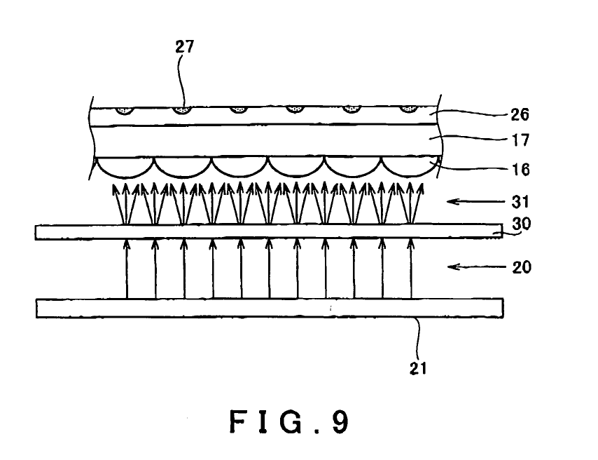

FIG. 9 shows a detail of the case when the ultraviolet ray is irradiated in the step shown in FIG. 6C or 7B. In the present embodiment, the parallel ultraviolet rays 20 irradiated from the ultraviolet lamp 21 are incident on the microlens array 16 after diffusing to a certain angle. Specifically, a transparent diffuser 30 is provided between the ultraviolet lamp 21 and the microlens array 16 and the parallel ultraviolet rays are inputted to the diffuser 30 from the ultraviolet lamp 21. The diffuser 30 diffuses the ultraviolet light20 corresponding to its diffusing characteristics and inputs the diffused ultraviolet light to the microlens array 16.

Here, when the microlens unit is built into the rear projection display 1, the incident angle of the image light incident on the microlens array 16 from the Fresnel lens 14 is set so that the outgoing light from the transmissive type screen 100 is converged at the position of 10 m to 20 m in the output direction. Thereby, the luminance of the center part of the transmissive type screen 100 may be increased preferentially over the peripheral part. Because a viewer watches the center part of the screen more than the peripheral part, it becomes possible to give an impression that the whole screen is bright to the viewer by preferentially increasing the luminance of the center part. This kind of method is effective particularly in using a CRT or the like whose overall luminance is lower than that of the other optical engine as the optical engine 2.

Corresponding to that, the diffusing angle of diffused ultraviolet light 31 includes variation of the incident angle of the image light incident on the microlens array 16 when the microlens unit 50 is built in the rear projection display 1. Thereby, the position or shape of the high cross-linking section 23 or 27 in the microlens unit 50 is formed so as to fully include optical paths of the image light in using the product.

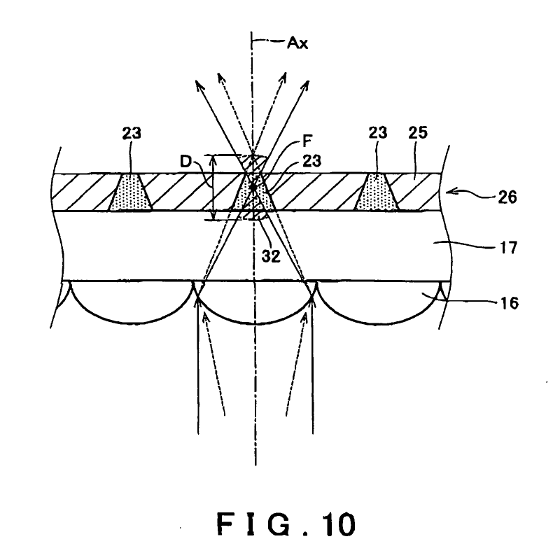

FIG. 10 is a drawing showing one exemplary detailed profile around the high cross-linking section 23. The high cross-linking section 23 and the opaque section 25 are formed as portions of the cross-linking dyeing layer 26 provided on the opposite side from the light source of the microlens array 16. The opaque section 25 is formed by dispersing the dye molecules in the portion of the cross-linking dyeing layer 26 and penetrates through the cross-linking dyeing layer 26 in the direction of the optical axis Ax. It is then capable of isolating the optical path of the image light in the cross-linking dyeing layer 26 per lenslet. That is, the optical paths of the adjacent lenslets are partitioned from each other by the opaque section 25. It enables the unit to effectively shut out unnecessary rays entering with a large angle of inclination with respect to the optical axis Ax. Still more, in terms of the cross section of the opaque section 25 in the direction vertical to the optical axis Ax, the side closer to the light source is smaller. It enables the opaque section 25 to shut out or absorb the unnecessary rays efficiently without hampering the image light.

A high-energy region 32 formed when the ultraviolet light incident on the microlens array 16 is converged has a thickness D in the direction of the optical axis centering on the focal point F of the lens. The high-energy region 32 advances the cross-linking reaction of the cross-linking dyeing layer 26. Here, the surface of the cross-linking dyeing layer 26 on the side father from the light source is positioned on the outside of the focal point F. Accordingly, the high cross-linking section 23 may be formed by efficiently utilizing the high-energy region 32.

When the cross-linking dyeing layer 26 is relatively thinner than the thickness D of the high-energy region 32, the high cross-linking section 23 is formed by penetrating through the cross-linking dyeing layer 26 in the direction of the optical axis Ax of the microlens array 16. In other words, the cross-linking density of the cross-linking dyeing layer 26 is increased across the whole thickness direction from the surface of the cross-linking dyeing layer 26 on the opposite side from the light source to the interface of the lens substrate 17 to form the high cross-linking section 23. Thereby, the dye will not turn toward the optical path of the image light and will not drop the transmission efficiency of the transmissive type screen 100 when the fluid medium 24 containing the dye contacts with the cross-linking dyeing layer 26.

It is noted that in FIG. 10, the dotted arrows indicate part of the diffused light shown in FIG. 9. The high-energy region 32 expands to a certain range by thus inputting the diffused ultraviolet light whose parallelism with the optical axis Ax of the lens is collapsed in forming the high cross-linking section 23. As a result, it allows the high cross-linking section 23 to be formed by cross-linking the cross-linking dyeing layer 26 having a wider range as compared to a case of inputting ultraviolet light parallel with the optical axis Ax. Because a refractive index of ultraviolet light in the microlens array 16 is higher than that of the image light, a focal distance in forming the high cross-linking section 23 is shorter than that in inputting the image light. However, according to the present embodiment, the diffused ultraviolet light whose parallelism is collapsed is inputted to the microlens array 16 as described above to expand the high-energy region 32 by the certain extent, the high cross-linking section 23 may be formed so as to have the range fully containing the optical path of the image light in actual use.

Still more, because the opaque section 25 is formed by having the dye molecules that absorb visible light within the cross-linking dyeing layer 26 which is transparent resin, it has a constant visible light transmissivity locally and micro-wise. Accordingly, the visible light transmissivity will not sharply change locally and micro-wise at the boundary part of the transparent high cross-linking section 23, which is the optical path of the image light, and the opaque section 25. In this case, diffraction hardly occurs at the boundary of the transparent section and the opaque section as compared to the conventional method of forming the opaque layer by partially breaking the black film after pasting it. Accordingly, the contrast and display quality of the transmissive type screen 100 may be improved further.

As it is apparent from the explanation described above, according to the embodiments of the invention, the opaque section of the microlens unit 50 maybe formed stably and accurately. Still more, because the opaque section is formed by dispersing the dye molecules within the cross-linked polymer matrix, it is mechanically strong and causes no problem such as peeling. That is, the embodiments of the invention can realize the rear projection display having the high contrast and display quality.

Although the invention has been described by way of the exemplary embodiments, it should be understood that those skilled in the art might make many changes and substitutions without departing from the spirit and scope of the invention. It is obvious from the definition of the appended claims that the embodiments with such modifications also belong to the scope of the invention.

What is claimed is:

1. A transmissive type screen, comprising: at least, from the side of a light source:
a microlens array comprising a plurality of microlenses;
a Fresnel lens disposed between said microlens array and a light source;
a transparent high cross-linking section formed at a focal point of each microlens of said microlens array; and
an opaque section around said high cross-linking section and said opaque section shuts out light by dye molecules dispersed therein.

2. The transmissive type screen as set forth in claim 1, wherein interval of molecules of said opaque section is larger than the interval of molecules of said high cross-linking section.

3. The transmissive type screen as set forth in claim 1, wherein said high cross-linking section is formed of light curable resin whose cross-linking advances by light energy and is cross-linked to have molecular interval finer than molecular size of said dye.

4. The transmissive type screen as set forth in claim 3, wherein said high cross-linking section and said opaque section are formed as portions of the light curable resin provided on the opposite side from the light source of said microlens array and said high cross-linking section is formed so as to penetrate through said light curable resin in the direction of said optical axis.

5. The transmissive type screen as set forth in claim 3, wherein the surface of said light curable resin farther from said light source is positioned on the outside of the focal point of said microlens array.

6. The transmissive type screen as set forth in claim 1, wherein said opaque section is composed of polymers including aromatic rings.

7. The transmissive type screen as set forth in claim 1, wherein said opaque section has a cross section in the direction vertical to said optical axis, which is smaller on the side closer to said light source.

8. The transmissive type screen as set forth in claim 1, wherein said opaque section is formed by dispersing dye molecules in part of a transparent resin layer provided on the opposite side from the light source of said microlens array and said opaque section penetrates through said transparent resin layer in the direction of said optical axis.

9. A manufacturing method of a transmissive type screen having at least, in order from the side of a light source, a Fresnel lens and a microlens array, comprising steps of:
forming a transparent light curable resin layer whose molecular interval is larger than the size of dye molecule to the vicinity of a focal point on the opposite side from a light source of said microlens array;
cross-linking said light curable resin layer in the vicinity of said focal point by irradiating light almost parallel with the optical axis of said microlens array from the light source side; and
forming an opaque section for shutting out light by said dye molecules dispersed in a non-cross-linked area of said resin layer by contacting fluid medium containing said dye molecules with said light curable resin layer.

10. The transmissive type screen manufacturing method as set forth in claim 9, wherein said light curable resin layer is formed to the outside of said focal point of said microlens array.

11. The transmissive type screen manufacturing method as set forth in claim 9, further comprising a step of dispersing said dye molecules in fluid medium whose affinity with said dye molecule is lower than said light curable resin layer as a step of preparing said fluid medium containing said dye molecules.

12. The transmissive type screen manufacturing method as set forth in claim 11, wherein said dye molecules are dispersed within fluid medium mainly composed of water as the step of preparing said fluid medium containing said dye molecules.

13. The transamissive type screen manufacturing method as set forth in claim 9, wherein a transparent diffuser is provided between the light source and said microlens array, almost parallel light is inputted to said diffuser and the outgoing light from said diffuser is inputted to said microlens array in the step of cross-linking the resin in the vicinity of said focal point.

14. A manufacturing method of a transmissive type screen having at least, in order from the light source side, a Fresnel lens and a microlens array, comprising steps of:
forming a transparent dyeable resin layer whose molecular interval is larger than the size of dye molecules to the vicinity of a focal point of said microlens array on said microlens array on the opposite side from the light source;
forming a transparent light curable resin layer on said dyeable resin layer on the opposite side from the light source;
cross-linking said light curable resin layer in the vicinity of said focal point by irradiating light almost parallel with the optical axis of said microlens array from the light source side; and
forming an opaque section for shutting out light by said dye molecules diffused within said dyeable resin layer by contacting fluid medium containing said dye molecules with said dyeable resin layer.
